(19) United States
(12) Patent Application Publication
(10) Pub. No.: US 2006/0029226 A1
(43) Pub. Date: Feb. 9, 2006

(54) Method of updating group key of secure group during new member's registration into the secure group and communication system using the method

(75) Inventors: Sung-hyu Han, Seoul (KR); Myung-sun Kim, Ulwang-si (KR); Ju-young Park, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/178,368

(22) Filed: Jul. 12, 2005

(30) Foreign Application Priority Data
Aug. 5, 2004 (KR) 10-2004-0061798

(51) Int. Cl. H04L 9/00

(52) U.S. Cl. 380/44

(57) ABSTRACT

A method of updating a group key in a secure group when a new member joins the secure group. The method includes: sending a private key to the new member after authentication of the new member; generating a new group key using a key generation function; encrypting the new group key with the private key and sending the encrypted new group key to the new member; and sending a key conversion flag, which indicates that an old group key has been updated. The key generation function is a deterministic function configured to generate the new group key using the old group key and is also configured to prevent generating the old group key using the new group key.

### CROSS-REFERENCE TO RELATED APPLICATIONS

This application claims the priority of Korean Patent Application No. 10-2004-0061798, filed on Aug. 5, 2004, in the Korean Intellectual Property Office, the disclosure of which is incorporated herein in its entirety by reference.

### BACKGROUND OF THE INVENTION

1. Field of the Invention

The present invention relates to a method of updating a group key and, more particularly, to a method of generating a new group key using an old group key when a new member registers in the group.

2. Description of the Related Art

A secure group denotes a group that provides secure communication against outsiders, while guaranteeing secure internal communication between members of the group. Of the keys used for message encryption, a key assigned to each member is called a private key, a key assigned to each sub-group is called a sub-group key, and a key assigned to the entire group is called a group key.

A member of the group has his/her own private key, one or more sub-group keys, i.e., a sub-group key for each sub-group the member participates in, and a group key. The member, however, cannot have a private key of another member, or any sub-group keys of sub-groups that the member does not participate in.

In addition, membership of the secure group changes when a new member registers in the secure group or an old member withdraws from the secure group. The change in the membership is followed by changes of the private keys, sub-group keys, and group key of the secure group. Specifically, if a new member joins the secure group, a new private key, sub-group key, and group key are assigned to the new member. If an old member leaves the secure group, all of the private key, sub-group key, and group key of the old member should be revoked. These keys should be revoked to avoid a possibility that the old member would harm the security of the secure group by using these keys after leaving the secure group.

A method of updating the group key in case of a new member's registration into the secure group depends on the topology of the secure group. There are two types of topologies, which are widely used. The two types of topologies are: a star-type topology and a tree-type topology.

Next, the method of updating the group key according to the topology of the secure group will be described. FIG. 1A is a key graph of a star-type secure group.

As depicted in FIG. 1A, a secure group includes members U1, U2, . . . , Un communicating with each other by exchanging messages, and a server S (not shown) offering the members a right to communicate and sending messages only to the members of the secure group.

A key graph depicted in FIG. 1A represents a structure of keys the server assigns to the members of the secure group. The shape of the key graph specifies the topology of the secure group.

Referring to FIG. 1A, the key graph of the star-type secure group includes a central node and a plurality of surrounding nodes. Each node is assigned an individual key. As depicted in FIG. 1A, the central node is assigned a group key K_{1˜M} and the surrounding nodes are assigned private keys K₁, K₂ . . . Kₙ. The surrounding nodes each correspond to users U1, U2, . . . Un, respectively. Each user U1, U2, . . . , or Un has two keys: a private key K1, K2, . . . , or Kn, and a group key K_{1˜m.}

Next, FIG. 1B is a key graph of a tree-type secure group.

The tree-type key graph, as depicted in FIG. 1B, is formed by merging at least two star-type key graphs. A tree is a hierarchical structure, which includes a central node as a top layer, a plurality of sub-nodes located in the middle layers, i.e., in lower layer or layers of the central node, and a plurality of user nodes located in the bottom layer, i.e., the lowest layer. The number of layers in one tree is referred to as a height, and the number of sub-nodes or user nodes for a node is referred to as a degree. The key graph of FIG. 1B has the height of 3, and the degree of 3.

In the tree-type structure such as the one depicted in FIG. 1B, each user U1, U2, . . . , or U9 has a respective private key K1, K2, . . . , or K9, a sub-group key K123, K456, . . . , K789, assigned to a sub-group the user joins, and a group key K1˜9 assigned to the central node. For example, in FIG. 1B, a user U5 has a private key K5, a sub-group key K456, and the group key K1˜9.

Table 1 shows the number of keys that each user has in cases of tree-type and star-type topologies. In the depicted table 1, d and h means a degree and a height of a tree, respectively. Furthermore, n means a number of users in the secure group. The equations used for the tree type topology yields an approximate value for the number of keys.

| | Star-type | Tree-type |
|---|---|---|
| The number of total keys | n + 1 | (dn)/(d − 1) |
| The number of keys | 2 | H |
| assigned to a user | | |

By using the key distribution structure of FIGS. 1A and 1B, the server S can send a message in a secure way only to a particular user. For example, in FIG. 1B, if the server S is required to send a message M only to users U1, U4, U5, and U6, the server just broadcasts E(K1, M), and E(K456, M). A user U1 can decrypt the message using the key K1, and users U4, U5, and U6 can decrypt the message with the sub-group key K456.

FIG. 2A shows key graphs of the star-type structure before and after a new member joins the secure group. On the left side of FIG. 2A, it is seen that existing members of the secure group are U1, U2, and U3. The user U1 has the private key K1 and the group key K123, the user U2 has the private key K2 and the group key K123, and the user U3 has the private key K3 and the group key K123. On the right side of FIG. 2A, it is shown that a new user U4 joins the secure group and is assigned a private key K4 and the group key is changed to K1234.

FIG. 2B is a flowchart of a method for updating the group key when a new user joins a secure group in a star topology, e.g., when a new user U4 joins the group, as depicted in FIG. 2A.

First, the user U4 sends a registration request message to the server S. The server S receives the request of the new member U4 in operation 210. Next, in operation 220, the server S authenticates the user U4, and if the authentication result is successful, the server S sends a private key K4 to the user U4. In operation 230, the server S creates a new group key K1234 based on a random number generation method. In operation 240, the server S encrypts the new group key K1234 with the private key K4, and sends the encrypted group key to the user U4.

Finally, in operation 250, the server S encrypts the new group key K1234 according to a previous Broadcasting Encryption Method before the registration of the user U4, and sends the encrypted group key to user U1, U2, and U3. For example, the server S may encrypt the new group key K1234 with the old group key K123, and send the result of the encryption to users U1, U2, and U3.

FIG. 3A shows a key graph in the tree-type structure before and after a new member joins the secure group.

On the left side of FIG. 3A, it is seen that existing members of the secure group are U1, U2, . . . , and U8. Users U1, U2, and U3 each have a sub-group key K123, a group key K1˜8, and a respective private key K1, K2, or K3. Users U4, U5, and U6 each have a sub-group key K456, the group key K1˜8, and a respective private key K4, K5, and K6. Users U7, and U8 each have sub-group key K78, the group key K1˜8, and a respective private key K7, and K8. On the right side of FIG. 3A, it is shown that a new user U9 joins the secure group.

FIG. 3B is a flowchart of a method for updating the group key when a new user joins a secure group in a tree-like topology, e.g., when a new user U9 joins the group, as depicted in FIG. 3A.

In particular, the user U9 sends a registration request message to the server S. The server S receives the request for registration of the new member U9 in operation 310. Next, in operation 320, the server S authenticates the user U9, and if the authentication result is successful, the server S sends a private key K9 to the user U9. Then, in operation 330, the server S creates a new sub-group key K789 and a new group key Kl9 based on any random number generation method.

In operation 340, the server S encrypts the new sub-group key K789 and the new group key K1˜9 with the private key K9, and sends the encrypted keys to the user U9.

Finally, in operation 350, the server S encrypts the new sub-group key K789 and/or the new group key K19 according to a previous Broadcasting Encryption Method before the registration of the user U9, and sends the encrypted keys/key to user U1, U2, . . . , and U8. For example, the server S may encrypt the new group key K19 with the old group key K1˜8 and send the result of the encryption to users U1, U2, . . . , and U6, and encrypt the new sub-group key K789 with the old sub-group key K78 and send the result to users U7 and U8.

According to this method of updating the group key, however, when a new member registers into the secure group, the server should send a new encrypted group key to existing members of the secure group, thereby increasing communication overhead and computational load of the server.

### SUMMARY OF THE INVENTION

In view of the shortcomings of this method in the related art, one object of the present invention is to provide a method of updating a group key of a secure group when a new member joins the secure group, which reduces communication overhead and computational load.

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

According to an aspect of the present invention, there is provided a method of updating a group key of a star-type secure group in case of a new member's registration into the secure group. This method includes: sending a private key to the new member after authentication of the new member; generating a new group key using a key generation function; encrypting the new group key with the private key and sending the encrypted new group key to the new member; and sending a key conversion flag indicating that an old group key has been updated to the old member. wherein the key generation function is a deterministic function configured to generate the new group key using the old group key and is configured to prevent the generation of the old group key using the new group key.

According to an aspect of the present invention, the key generation function generates pseudo-random numbers using the old group key as a seed.

According to an aspect of the present invention, the key generation function generates the new group key by encrypting the old group key with the same old group key.

According to an aspect of the present invention, when the key conversion flags are received, the old members of the secure group generate the new group key according to the key generation function.

According to another aspect of the present invention, a method of updating a group key of a tree-type secure group when a new member joins the secure group is provided.

The method includes: sending a private key to the new member after authentication of the new member; generating a new group key and at least one sub-group key using a key generation function; encrypting the new group key and the at least one sub-group key with the private key and sending the encrypted keys to the new member; and sending to old members a key conversion flag indicating that an old group key has been updated.

The key generation function is a deterministic function configured to generate the new group key and the at least one new sub-group key using the old group key and old sub-group key, respectively, and is configured to prevent generating the old group key and the old-sub-group key using the new group key and the at least one new sub-group key.

According to an aspect of the present invention, the key generation function generates pseudo-random numbers using the old group key or one or more old sub-group keys as a seed.

According to an aspect of the present invention, the key generation function generates the new group key or one or more new sub-group keys by encrypting the old group key or respective one or more old sub-group keys with the same old group key or the same respective one or more old sub-group keys.

According to an aspect of the present invention, when the key conversion flags are received, the old members of the secure group generate the new group key or one or more new sub-group keys according to the key generation function.

According to still another aspect of the present invention, a communication system for a secure group having at least two members and at least one sub-group that includes the two members. In this system, each sub-group key assigned to a sub-group where in the two members participate and a group key assigned to the secure group are updated when a new member joins the secure group.

Moreover, in this system, new sub-group keys and a new group key are generated according to a key generation function. The key generation function is a function configured to generate the new group key or the new sub-group keys using the old group key or the old sub-group keys, and is configured to prevent generation of the old group key or the old sub-group keys using the new group key or the new sub-group keys.

According to an aspect of the present invention, the key generation function generates pseudo-random numbers using the old group key or the old sub-group keys as a seed.

According to an aspect of the present invention, the key generation function generates the new group key or the new sub-group keys by encrypting the old group key with the same old group key or encrypting the old sub-group keys with the same old sub-group keys.

According to yet another aspect of the present invention, a recording medium accessible by a computer is provided. The recording medium stores a computer program for executing the method of updating a group key of a star-type secure group when a new member joins the secure group.

### BRIEF DESCRIPTION OF THE DRAWINGS

The present invention will now be described in detail by describing illustrative, non-limiting embodiments thereof with reference to the accompanying drawings. In the drawings, the same reference characters denote analogous elements:

FIG. 1A shows a key graph of a star-type secure group;

FIG. 1B shows a key graph of a tree-type secure group;

FIG. 2A shows key graphs of a star-type secure group before and after a new registration into the secure group;

FIG. 2B is a flowchart illustrating a related art method of updating a group key depicted in FIG. 2A;

FIG. 3A shows key graphs of a tree-type secure group before and after a new registration into the secure group;

FIG. 3B is a flowchart illustrating a related art method of updating a group key depicted in FIG. 3A;

FIG. 4 shows a key graph of a star-type secure group according to a first illustrative, non-limiting embodiment of the present invention;

FIG. 5 is a flowchart illustrating a method of updating a group key in a tree-type secure group, according to the first embodiment of the present invention;

FIG. 6 is a flowchart illustrating a method of updating a group key in a star-type secure group, according to a second, illustrative, non-limiting embodiment of the present invention;

FIG. 7 shows a key graph of a tree-type secure group;

FIG. 8 is a flowchart illustrating a method of updating a group key in a tree-type secure group depicted in FIG. 7, according to a third, illustrative, non-limiting embodiment of the present invention; and

FIG. 9 is a flowchart illustrating a method of updating a group key in a tree-type secure group depicted in FIG. 7, according to a fourth, illustrative, non-limiting embodiment of the present invention.

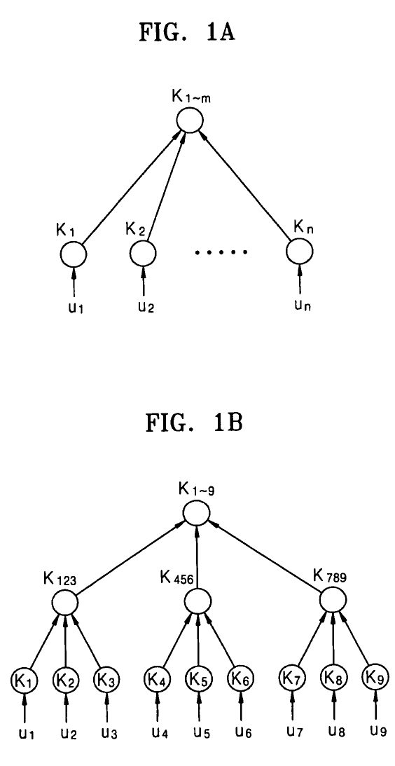

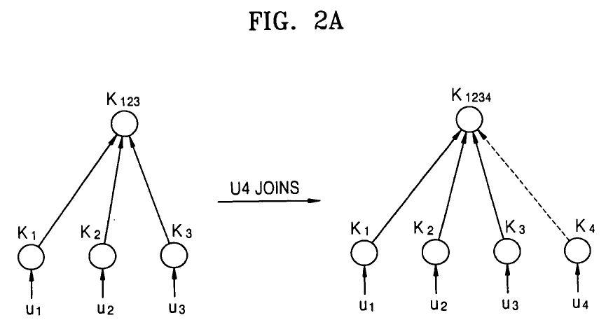

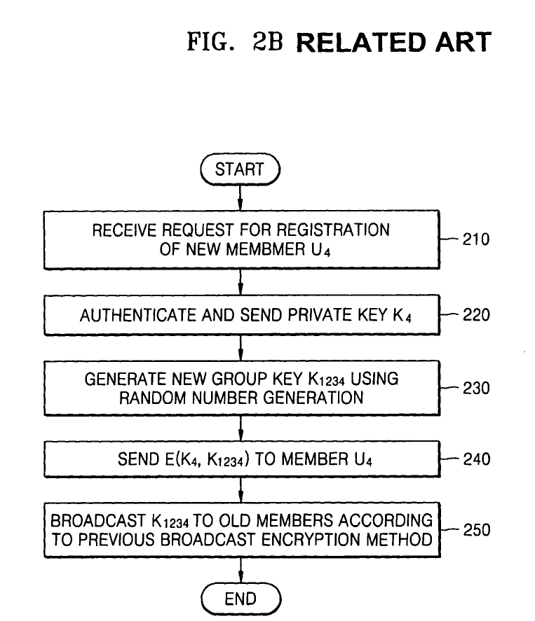

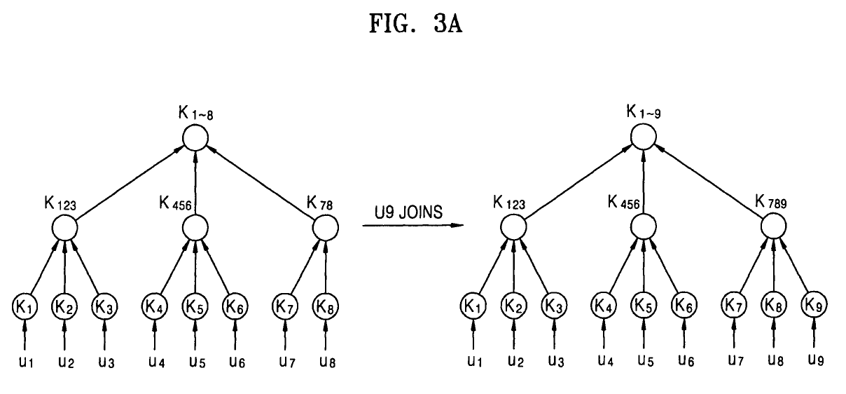

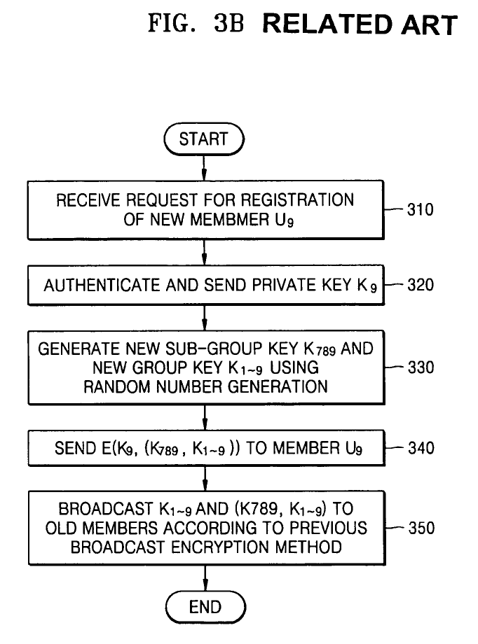

### DETAILED DESCRIPTION OF THE ILLUSTRATIVE, NON-LIMITING EMBODIMENTS OF THE PRESENT INVENTION

Exemplary, non-limiting embodiments of the present invention will now be described in detail with reference to the attached drawings.

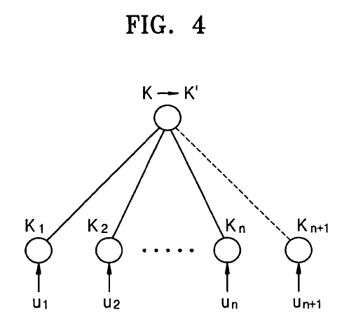

FIG. 4 shows a key graph of a star-type secure group G.

The secure group G is comprised of members U1, U2, . . . , Un. Each member has two keys: a private key K1, K2, . . . , or Kn, and an existing group key K.

In FIG. 4, it is seen that a user Un+1 is about to join the secure group G as a new member. Hence, the server will generate a new key Kn+1 and the server is also about to generate a new group key K′.

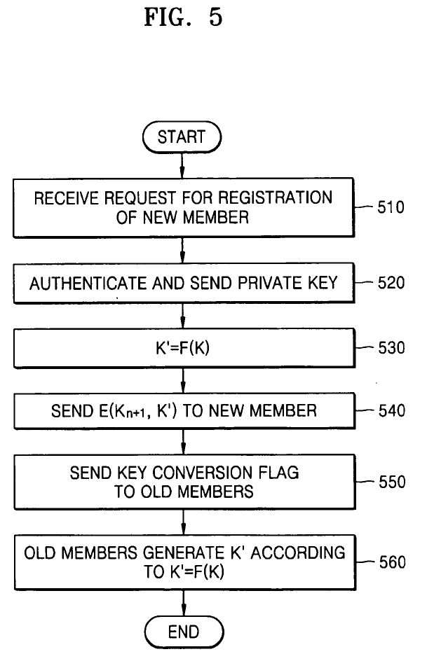

FIG. 5 is a flowchart illustrating a method, according to the first, exemplary, non-limiting embodiment of the present invention, of updating a group key in the star-type topology such as the secure group G depicted in FIG. 4,.

To begin, a user Un+1 is about to join the secure group G. Therefore, the user Un+1 sends a registration request message to the server S. In operation 510, the server S receives the request for registration of the new member and in operation 520, the server S authenticates the user Un+1. If the authentication result is successful, the server S sends a private key Kn+1 to the user Un+1. Then, in operation 530, the server S creates a new group key K′ with the old group key K. For example, the new group key K′ is expressed in equation (1):
K′=F(K) (1).

Here, F( ) represents a deterministic key generation function that generates a pseudo-random number with the old group key K as a seed. The key generation function F( ) has a characteristic that it is impossible to recover the old group key with the new group key.

Next, in operation 540, the server S encrypts the new generated group key K′ with the private key Kn+1 for the user Un+1, and sends the encrypted new group key to the user Un+1. In operation 550, the server S sends users U 1, U2, . . . , Un a key conversion flag indicating that the old group key has been updated. Finally, in operation 560, upon receiving the key conversion flag, users U 1, U2, . . . , Un recover the new group key K′ with the old group key K according to the equation (1).

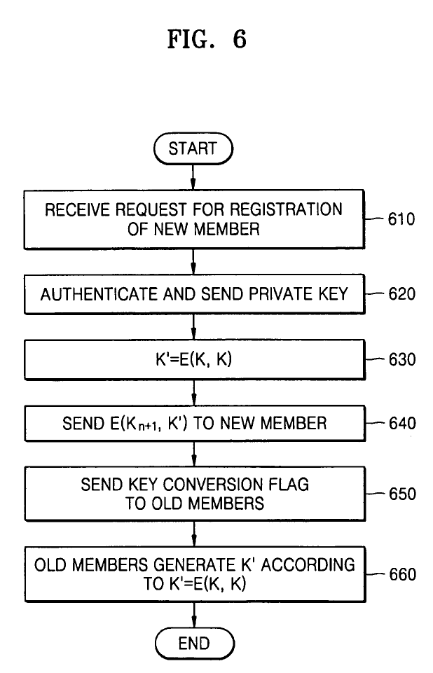

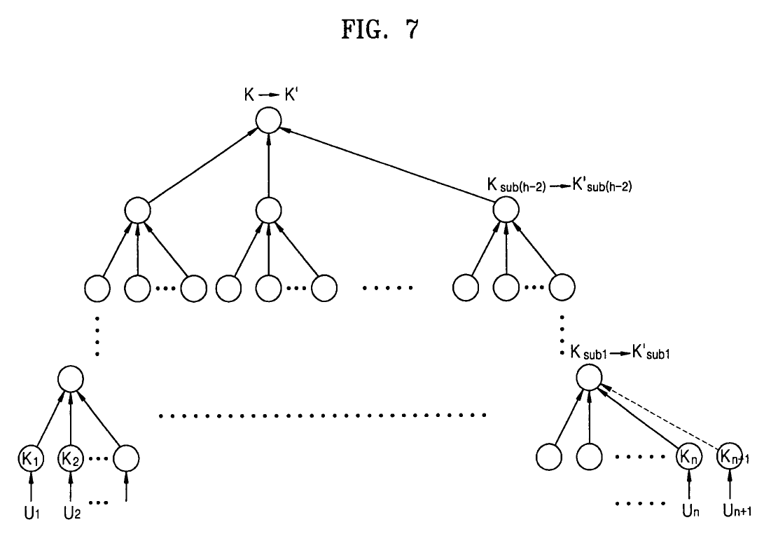

FIG. 6 is a flowchart illustrating a method, according to a second embodiment of the present invention, of updating the group key in the star-type topology such as the secure group G depicted in FIG. 4.

First, a user Un+1, who is about to join the secure group G, sends a registration request message to the server S. The server S receives the request for registration of the new member, in operation 610. In operation 620, the server S authenticates the user Un+1, and if the authentication result is successful, the server S sends a private key Kn+1 to the user Un+1. Next, in operation 630, the server S creates a new group key K′ by encrypting the old group key K with the old group key K. For example, the new group key K′ is expressed in equation (2):
K′=E(K, K) (2).

Then, in operation 640, the server S encrypts the new generated group key K′ with the private key Kn+1 for the user Un+1, and sends the encrypted new group key to the user Un+1. Moreover, in operation 650, the server S sends users U1, U2, . . . , Un a key conversion flag indicating that the old group key has been updated.

Finally, in operation 660, upon receiving the key conversion flag, each of the users U 1, U2, . . . , Un recovers the new group key K′ with the old group key K according to equation (2).

In the exemplary embodiment depicted in FIG. 6, the old group key K cannot be generated from the new group key K′ in the function E( ) as expressed in the equation (2). As such, deriving the old key from the new key is impossible because it is impossible to figure out a decryption key to decrypt an encrypted text when a pair of plaintext and the encrypted text is inserted in the function E( ).

FIG. 7 shows another key graph of a tree-type secure group G.

The secure group G is comprised of members U1, U2, . . . , Un and has a structure of height of h and degree of d. Each member has his/her own private key, one of K1, K2, . . . , and Kn, a sub-group key, h-2 number of sub-group keys where the member involves, Ksub1, Ksub2, . . . , and Ksub(h−2), and a group key K, which is a total of 1+(h−2)+1=h number of keys. Here, h is a height of the tree.

Referring to FIG. 7, a user Un+1 is about to join the secure group G as a new member, which will cause the server S to generate a new group key K′ and new sub-group keys K′sub1, K′sub2, . . . , and K′sub(h−2).

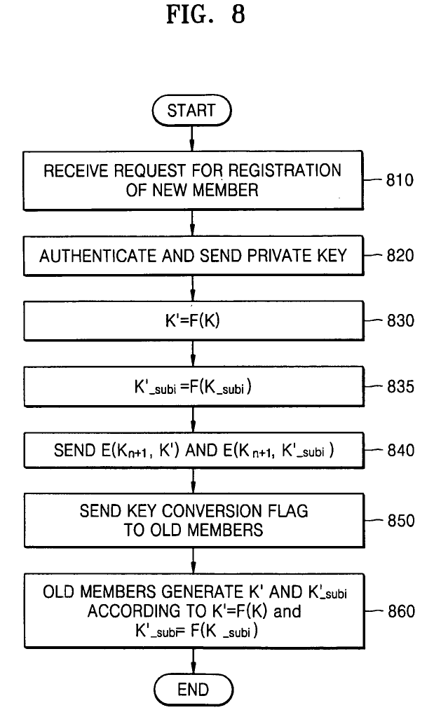

FIG. 8 is a flowchart of a method of updating the group key in the tree-type secure group G of FIG. 7, according to a third, illustrative, non-limiting embodiment of the present invention.

First, a user Un+1 who is about to join the secure group G sends a registration request message to the server S. The server S receives the request for registration of the new member. The server S, then, in operation 820, authenticates the user Un+1, and if the authentication result is successful, the server S sends a private key Kn+1 to the user Un+1. Next, in operation 830, the server S generates a new group key K′ according to the equation (1). In operation 835, the server S generates new sub-Group keys K′_sub1, K′_sub2, . . . , and K′_sub(h−2) according to an equation (3):
K′_{—}subi=F(K_{—}subi) (3).

In this equation (3), K_subi is one of the old sub-group keys, which corresponds to the i-th layer, and the K′_subi is its new sub-group key.

Next, in operation 840, the server S encrypts the new generated group key K′ and sub-group keys K′_sub1, K′_sub2, . . . , and K′_sub(h−2) with the private key Kn+1 for the user Un+1, and sends the encrypted new group key and the sub-group keys to the user Un+1. In operation 850, the server S sends users U1, U2, . . . , and Un key conversion flags indicating that the old group key has been updated.

Finally, in operation 860, upon receiving the key conversion flag, each user U1, U2, . . . , or Un recovers the new group key K′ with the old group key K, and the corresponding new sub-group keys K′_sub1, K′_sub2, . . . and K′_sub(h−2) with the old sub-group keys K_sub1, K_sub2, . . . , and K_sub(h−2), according to the equations (1) and (3).

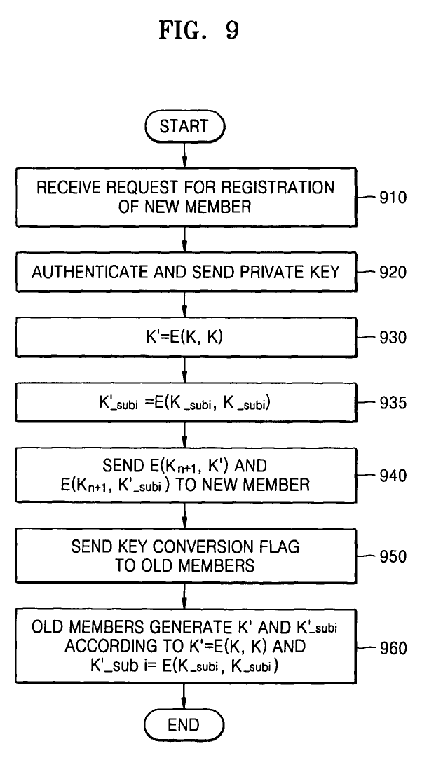

FIG. 9 is a flowchart illustrating a method, according to an illustrative, non-limiting, fourth embodiment of the present invention, of updating the group key of the tree-type topology such as the secure group G depicted in FIG. 7,.

First, a user Un+1, who is about to join the secure group G, sends a registration request message to the server S. Then, in operation 910, the server S receives the request for registration of a new member. In operation 920, the server S authenticates the user Un+1, and if the authentication result is successful, the server S sends a private key Kn+1 to the user Un+1. Next, in operation 930, the server S generates a new group key K′ according to the equation (2). In operation 935, the server S generates new sub-Group keys K′_sub 1, K′_sub2 . . . , and K′_sub(h−2) according to equation (4):
K′_{—}subi=E(K_{—}subi, K_{—}subi) (4)

In the equation (4), K_subi is one of the old sub-group keys, which corresponds to the i-th layer, and the K′ subi is its new sub-group key.

Next, in operation 940, the server S encrypts the new generated group key K′ and sub-group keys K′_sub1, K′_sub2, . . . , and K′_sub(h−2) with the private key Kn+1 for the user Un+1, and sends the encrypted new group key and the sub-group keys to the user Un+1. In operation 950, the server S sends users U1, U2, . . . , and Un key conversion flags indicating that the old group key has been updated.

Finally, in operation 960, upon receiving the key conversion flag, each user U1, U2, . . . , or Un recovers the new group key K′ with the old group key K according to the equation (2), and the corresponding new sub-group keys K′_sub1, K′_sub2, . . . , and K′_sub(h−2) with the old sub-group keys K_sub1, K_sub2, . . . , or K_sub(h−2) according to the equation (4).

As such, there is no need for the server S to have a conventional random generator for generating a new group key or new sub-group key(s) when a new member joins a secure group. Consequently, the computational load is reduced. In addition, instead of sending the actual new group key to all members of the group, the server S only sends such a key conversion flag indicating a need to generate the new group key to all members of the secure group, thereby considerably reducing the communication overhead.

It is possible for the method of updating a group key described above according to the present invention to be implemented as a computer program. Codes and code segments constituting the computer program may readily be inferred by those skilled in the art. The computer programs may be recorded on computer-readable media and read and executed by computers. Such computer-readable media include all kinds of storage devices, such as ROM, RAM, CD-ROM, magnetic tape, floppy disc, optical data storage devices, etc. The computer readable media also include everything that is realized in the form of carrier waves, e.g., transmission over the Internet. The computer-readable media may be distributed to computer systems connected to a network, and codes on the distributed computer-readable media may be stored and executed in a decentralized fashion.

The above description of illustrative, non-limiting embodiments has been given by way of an example only. The above and other features of the invention including various novel method steps and a system of the various novel components have been particularly described with reference to the accompanying drawings and pointed out in the claims. It will be understood that the particular process and construction of parts embodying the invention is shown by way of an illustration only and not as a limitation of the invention. The principles and features of this invention may be employed in varied and numerous embodiments without departing from the scope and the spirit of the invention as defined by the appended claims and equivalents thereof.

What is claimed is:

1. A method of updating a group key of a star-type secure group when a new member joins the secure group, the method comprising:
sending a private key to the new member after authentication of the new member;
generating a new group key using a key generation function;
encrypting the new group key with the private key and sending the encrypted new group key to the new member; and
sending a key conversion flag indicating that an old group key has been updated to old members of the secure group,
wherein the key generation function is a deterministic function configured to generate the new group key using the old group key but is configured to prevent generating the old group key using the new group key.

2. The method of claim 1, wherein the key generation function generates pseudo-random numbers using the old group key as a seed.

3. The method of claim 1, wherein the key generation function generates the new group key by encrypting the old group key with the same old group key.

4. The method of claim 1, wherein when the key conversion flags are received, the old members of the secure group generate the new group key according to the key generation function.

5. A method of updating a group key of a tree-type secure group when a new member joins the secure group, the method comprising:
sending a private key to the new member after authentication of the new member;
generating a new group key and at least one sub-group key using a key generation function;
encrypting the new group key and the at least one sub-group key with the private key and sending the encrypted keys to the new member; and
sending to old members of the secure group a key conversion flag indicating that an old group key has been updated,
wherein the key generation function is a deterministic function configured to generate the new group key and the at least one new sub-group key using the old group key and old sub-group key, respectively, and is configured to prevent generating the old group key and the old-sub-group key using the new group key and the at least one new sub-group key.

6. The method of claim 5, wherein the key generation function generates pseudo-random numbers using the old group key or the old sub-group key as a seed.

7. The method of claim 5, wherein the key generation function generates the new group key or the at least one new sub-group key by encrypting the old group key or the old sub-group key with the same old group key or the same old sub-group key.

8. The method of claim 5, wherein when the key conversion flags are received, the old members of the secure group generate the new group key or the at least one new sub-group key according to the key generation function.

9. A communication system for a secure group having at least two members and at least one sub-group including the two members,
wherein each sub-group key assigned to a sub-group wherein the two members participate and a group key assigned to the secure group are updated when a new member joins the secure group,
wherein new sub-group keys and a new group key are generated according to a key generation function,
wherein the key generation function is a function configured to generate the new group key or the new sub-group keys using the old group key or the old sub-group keys, and is configured to prevent generating the old group key or the old sub-group keys using the new group key or the new sub-group keys.

10. The system of claim 9, wherein the key generation function generates pseudo-random numbers using the old group key or the old sub-group keys as a seed.

11. The system of claim 9, wherein the key generation function generates the new group key or the new sub-group keys by encrypting the old group key with the same old group key or encrypting the old sub-group keys with the same old sub-group keys.

12. A recording medium accessible by a computer, storing a computer program for executing a method of updating a group key of a star-type secure group when a new member joins the secure group, the method comprising:
sending a private key to the new member after authentication of the new member;
generating a new group key using a key generation function;
encrypting the new group key with the private key and sending the encrypted new group key to the new member; and
sending a key conversion flag indicating that an old group key has been updated to old members of the secure group,
wherein the key generation function is a deterministic function configured to generate the new group key using the old group key but is configured to prevent generating the old group key using the new group key.
